(19) United States
(12) Patent Application Publication
(10) Pub. No.: US 2011/0014957 A1
(43) Pub. Date: Jan. 20, 2011

(54) HEADSET

(75) Inventors: Yasuo Sugimori, Osaka (JP); Yasuhiro Shigeno, Osaka (JP)

Correspondence Address: RANKIN, HILL & CLARK LLP, 38210 GLENN AVENUE, WILLOUGHBY, OH, 44094-7808, US

(73) Assignee: HOSIDEN CORPORATION, Osaka (JP)

(21) Appl. No.: 12/832,629

(22) Filed: Jul. 8, 2010

(30) Foreign Application Priority Data
Jul. 14, 2009 (JP) 2009-165275

(51) Int. Cl. H04W 4/00

(52) U.S. Cl. 455/569.1

(57) ABSTRACT

The invention provides a headset which has a service environment adaptability. The headset 1 has: a first microphone 3 which picks up a voice sound emitted from the mouth; an earphone/microphone unit 5 in which a built-in speaker 4 functions also as a second microphone which picks up a voice sound generated in the ear; and a mode switchover switch circuit 41 which switches over between a first call mode where the first microphone 3 and a speaker function of the earphone/microphone unit 5 are caused to operate, and a second call mode where a microphone function and speaker function of the earphone/microphone unit 5 are caused to operate.

### TECHNICAL FIELD

The present invention relates to a headset which is connected to, for example, a portable telephone to perform a handsfree call.

### BACKGROUND ART

A usual headset (for example, see Patent Literature 1) comprises an earphone, and a microphone which picks up a voice sound emitted from the mouth. When such a headset is used in a noisy atmosphere, the microphone picks up also ambient noises together with a voice sound emitted from the mouth of a person who uses the headset (hereinafter, referred to as the headset user), and hence there is a problem in that the voice sound of the headset user is hardly heard by the other party.

In order to solve the problem of a usual headset, a headset which is not provided with a microphone that picks up a voice sound emitted from the mouth of the headset user has been proposed. For example, Patent Literature 2 discloses a headset which comprises an earphone type microphone that is to be attached to one of the ears, and an earphone that is to be attached to the other ear, and Patent Literature 3 discloses a headset which comprises an earphone in which a built-in speaker has a microphone function.

In such a headset which is not provided with a microphone which picks up a voice sound emitted from the mouth of the headset user, a voice sound (air vibration) which is generated in the ear when the headset user produces voice is picked up by the earphone type microphone or the earphone having a microphone function. Therefore, little ambient noise is picked up, the voice sound of the headset user can be easily heard by the other party, and a clear call is realized in a noisy atmosphere.

### PRIOR ART LITERATURE

### Patent Literature

[Patent Literature 1] Japanese Patent Application Laying-Open No. 2004-64537

[Patent Literature 2] Japanese Patent Application Laying-Open No. 2007-228344

[Patent Literature 3] Japanese Patent Application Laying-Open No. 2001-157292

### SUMMARY OF THE INVENTION

### Problem to be Solved by the Invention

In a headset, from the viewpoint of obtaining a transmission audio signal which is similar to a natural voice sound, pick-up of a voice sound emitted from the mouth is more advantageous than that of a voice sound generated in the ear. In a quiet atmosphere, particularly, a microphone which picks up a voice sound emitted from the mouth is effective.

However, a conventional headset based on the background art can pick up only one of a voice sound emitted from the mouth and that generated in the ear, and lacks the service environment adaptability.

It is an object of the invention to provide a headset which has both a usual headset function (in which a call is made while using an earphone and a microphone for picking up a voice sound emitted from the mouth), and a function of picking up a voice sound generated in the ear, in which the two functions can be easily switched over, and which therefore has a service environment adaptability.

### Means for Solving the Problem

In order to attain the object, the headset of the invention (Invention 1) comprises: a first microphone which picks up a voice sound emitted from the mouth; an earphone/microphone unit in which a built-in speaker functions also as a second microphone which picks up a voice sound generated in the ear; and a mode switchover switch circuit which switches over between a first call mode and a second call mode. In the first call mode, the first microphone and a speaker function of the earphone/microphone unit are caused to operate, and, in the second call mode, a microphone function and speaker function of the earphone/microphone unit are caused to operate.

The headset of the other invention (Invention 2) comprises: a first microphone which picks up a voice sound emitted from the mouth; an earphone/microphone unit which separately incorporates a speaker and a second microphone which picks up a voice sound generated in the ear; and a mode switchover switch which switches over between a first call mode and a second call mode. In the first call mode, the first microphone and the speaker of the earphone/microphone unit are caused to operate, and, in the second call mode, the speaker and second microphone of the earphone/microphone unit are caused to operate.

### EFFECTS OF THE INVENTION

According to Invention 1, or Invention 2, in the first call mode, the usual headset function is exerted, and, in the second call mode, a function of picking up a voice sound generated in the ear is exerted. Therefore, it is possible to provide a headset which has both the usual headset function and the function of picking up a voice sound generated in the ear, in which the two functions can be easily switched over, and which therefore has a service environment adaptability.

### BRIEF DESCRIPTION OF THE DRAWINGS

FIG. 1 is a perspective view showing an appearance of a headset which is an embodiment of Invention 1.

FIG. 2 is a sectional view showing the internal structure of the headset of FIG. 1.

FIG. 3 is a sectional view of a speaker of an earphone/microphone unit of the headset of FIG. 1.

FIG. 4 is a schematic block diagram of a Bluetooth module of the headset of FIG. 1.

FIG. 5 is a sectional view of main portions of a headset which is an embodiment of Invention 2.

FIG. 6 is a schematic block diagram of a Bluetooth module of the headset of FIG. 5.

### MODE FOR CARRYING OUT THE INVENTION

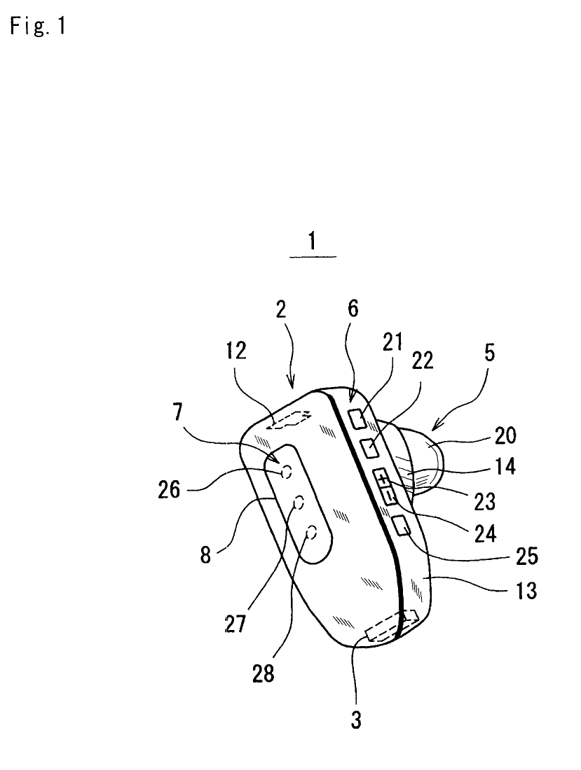

Hereinafter, an embodiment of Invention 1 will be described with reference to FIGS. 1 to 4.

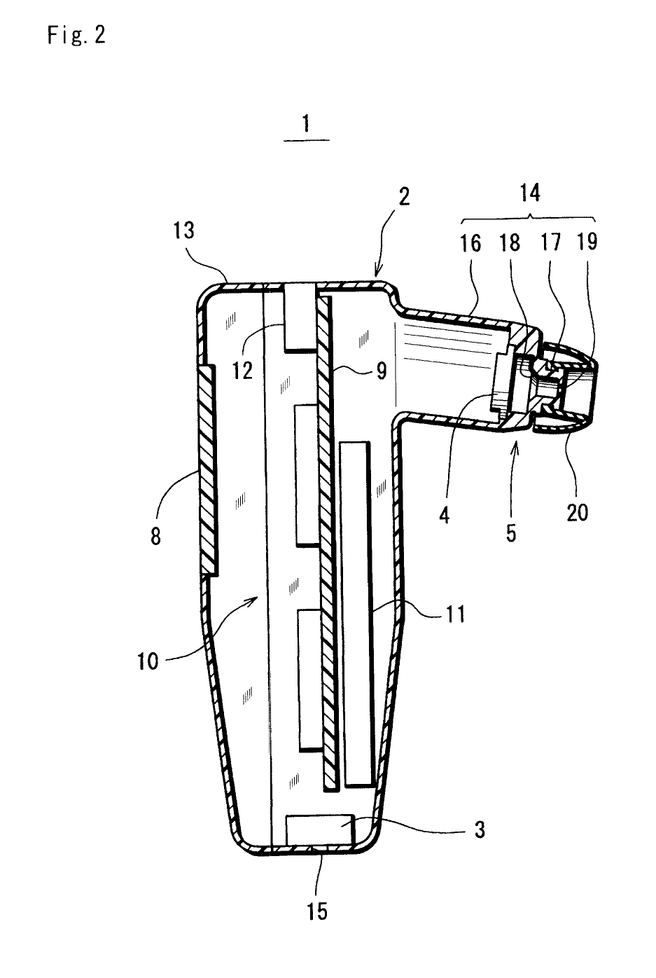

FIG. 1 is a perspective view showing an appearance of a headset which is an embodiment of Invention 1, and FIG. 2 is a sectional view showing the internal structure of the headset of FIG. 1.

As shown in FIGS. 1 and 2, the headset 1 comprises: a headset housing 2; a first microphone 3; an earphone/microphone unit 5 which incorporates a speaker 4; a plurality of switch buttons 6 for performing various operations of the headset 1; a plurality of LEDs (Light Emitting Diodes) 7 for displaying various states of the headset 1; an LED displaying portion 8 which is transparent or translucent, and which is used for displaying various states of the headset 1 while using the LEDs 7 as backlights; a Bluetooth (registered trademark) module 10 configured by various circuit elements, integrated circuits, and the like which are mounted on a printed circuit board 9; a secondary battery 11; and a Mini-USB (Universal Serial Bus) connector socket 12 for charging.

The headset housing 2 is configured by a housing main portion 13, and an earphone/microphone housing portion 14. The switch buttons 6, the LED displaying portion 8, and the Mini-USB connector socket 12 are disposed in the housing main portion 13. The Bluetooth module 10 and the secondary battery 11 are housed in the housing main portion 13. In the housing main portion 13, the earphone/microphone housing portion 14 is projectingly formed on one end side, and a sound-pick up hole 15 is disposed on the other end side. The first microphone 3 is disposed inside the sound-pick up hole 15. The first microphone 3 picks up a voice sound emitted from the mouth of the headset user, through the sound-pick up hole 15.

The earphone/microphone housing portion 14 is formed into a stepped tubular shape, and has a large-diameter portion 16 in the base side of the tubular shape, and a small-diameter portion 17 in the tip-end side of the tubular shape. A sound guiding hole 18 is formed inside the tubular shape, and a sound hole 19 through which the sound guiding hole 18 communicates to the outside is opened in the tip end of the tubular shape. The speaker 4 is disposed in the rear side (in the middle of the sound guiding hole 18) of the large-diameter portion 16, and a canal-shaped earpiece 20 made of an elastic material such as silicone rubber is fitted onto the small-diameter portion 17. The earphone/microphone unit 5 is configured by the thus configured earphone/microphone housing portion 14, the speaker 4, and the earpiece 20. The earphone/microphone unit 5 is formed into a canal type earphone shape, and used while being inserted into the external auditory canal of one of the ears.

The switch buttons 6 include switch buttons for basic operations of the headset 1, such as: a power source switch button 21 for performing an operation of turning on/off the power source; a hook switch button 22 for performing an operation of answering/terminating a call at call incoming; and volume up/down switch buttons 23, 24 for increasing/decreasing the volume level in a call, and further a mode switchover switch button 25 for selecting which of first and second call modes is used in the headset 1.

The LEDs 7 include LEDs such as: a power source state displaying LED 26 which displays the power source state such as the on/off state of the power source of the headset 1, and the low voltage/full charge state of the secondary battery 11; and a communication state displaying LED 27 which displays the communication state of the headset 1 such as call incoming and answering/terminating, and further a mode displaying LED 28 for displaying which of the first and second call modes is used in the headset 1.

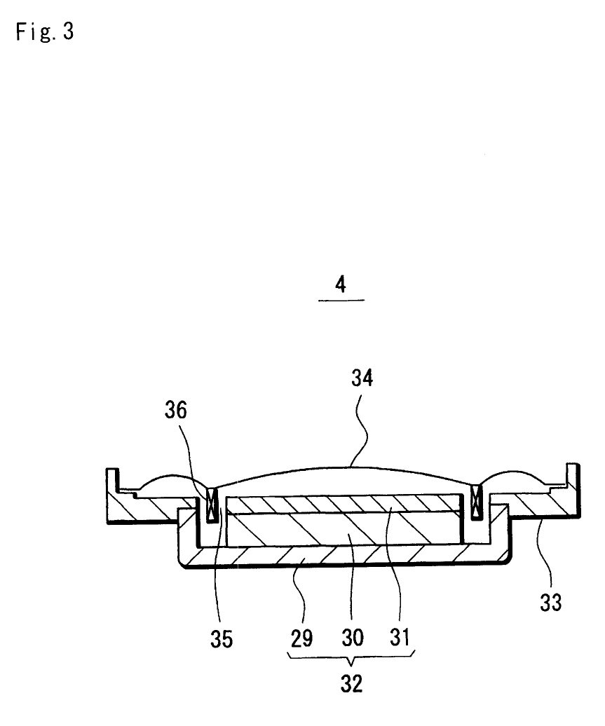

FIG. 3 is a sectional view of the speaker of the earphone/microphone unit of the headset of FIG. 1.

As shown in FIG. 3, the speaker 4 is configured by: a magnetic circuit 32 configured by a yoke 29, a magnet 30, and a pole piece 31; a frame 33 which is coupled to the magnetic circuit 32; a diaphragm 34 in which an outer peripheral edge portion is bonded and fixed to that of the frame 33; a voice coil 36 in which one end is coupled to the diaphragm 34, and which is inserted into a magnetic gap 35 of the magnetic circuit 32 in a piston-motion enabled manner; and the like.

The speaker 4 is disposed in the earphone/microphone housing portion 14 so that the diaphragm 34 is opposed to the sound hole 19, and has: a speaker function in which, on the basis of an audio signal supplied to the voice coil 36 from an external circuit, the voice coil 36 is driven to vibrate the diaphragm 34, thereby generating a sound; and a microphone function in which the diaphragm 34 receives a voice sound (air vibration) which is generated in the ear when the headset user produces voice, and the voice coil 36 is driven to generate an electromotive force, thereby producing an audio signal. In the headset 1, the first microphone 3 picks up a voice sound emitted from the mouth of the headset user, and the speaker 4 which is incorporated in the earphone/microphone unit 5 functions also as a second microphone which picks up a voice sound generated in the ear when the headset user produces voice.

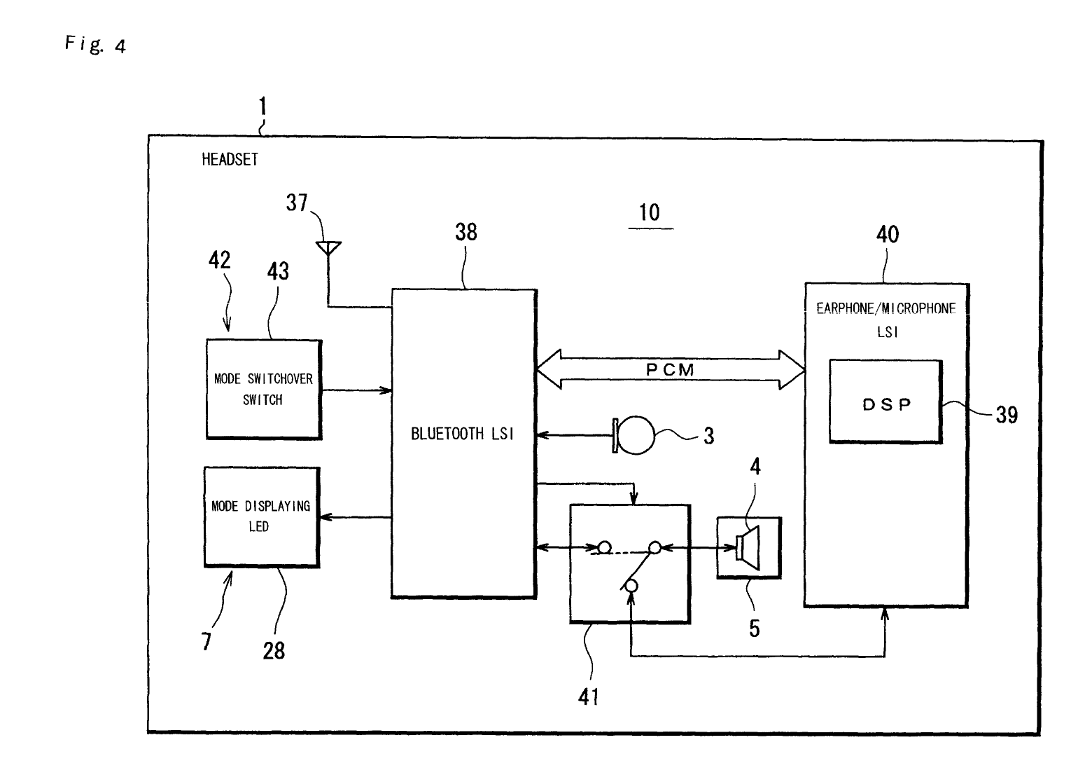

FIG. 4 is a schematic block diagram of the Bluetooth module of the headset of FIG. 1.

As shown in FIG. 4, the Bluetooth module 10 comprises: the first microphone 3; the earphone/microphone unit 5; an antenna 37; a Bluetooth LSI (Large Scale Integration) 38; an earphone/microphone LSI 40 which incorporates a DSP (Digital Signal Processor) 39; a mode switchover switch circuit 41 which switches over between the first call mode and the second call mode; a plurality of switches 42 for turning on the power source for the headset 1, and inputting various operation signals; and the LEDs 7.

The switches 42 include: a power source switch which is turned on/off by operating the power source switch button 21; a hook switch which is turned on/off by operating the hook switch button 22; a volume up switch which is operated by operating the volume up switch button 23; and a volume down switch which is operated by operating the volume down switch button 24, and further a mode switchover switch 43 which is turned on/off by operating the mode switchover switch button 25.

Bluetooth is a short-range wireless communication standard for exchanging information between devices (apparatuses) which are close to each other, by means of radio waves of a frequency band of 2.4 GHz. The Bluetooth LSI 38 performs transmission/reception of a voice sound and its control with respect to a portable telephone (an example of a telephone such as a portable telephone, a PHS (Personal Handy-phone System) telephone, a Smart phone, and a fixed-line telephone) having a Bluetooth wireless communication function, by means of Bluetooth wireless communication, and also various controls in the headset 1. The first microphone 3, the speaker 4 of the earphone/microphone unit 5, the antenna 37, the earphone/microphone LSI 40, the mode switchover switch circuit 41, the switches 42, the LEDs 7, and the secondary battery 11 are connected to the Bluetooth LSI 38.

The first microphone 3 is always connected to the Bluetooth LSI 38, and the speaker 4 of the earphone/microphone unit 5 is switchably connected to the Bluetooth LSI 38 and the earphone/microphone LSI 40 by the mode switchover switch circuit 41.

The Bluetooth LSI 38 and the earphone/microphone LSI 40 are connected to each other through a PCM (Pulse Code Modulation) interface, and audio data can be exchanged through the interface. In this case, the Bluetooth LSI 38 produces a synchronization signal on the basis of a quartz oscillator (not shown) which is connected to the LSI, and supplies the signal to the earphone/microphone LSI 40. Therefore, the Bluetooth LSI is the master, and the earphone/microphone LSI 40 is a slave.

The earphone/microphone LSI 40 supplies PCM output audio data (reception audio signal) from the Bluetooth LSI 38, to the DSP 39, and the data are supplied from the DSP to the speaker 4 of the earphone/microphone unit 5 through the external mode switchover switch circuit 41 via a DAC (Digital to Analog Converter) (not shown). A transmission audio signal which is supplied from the speaker 4 of the earphone/microphone unit 5 through the switch circuit 41 is received by the DSP 39 via a ADC (Analog to Digital Converter) (not shown), and subjected to a digital signal process in the DSP, and then PCM data are supplied to the Bluetooth LSI 38. In the case where a bidirectional call of the full-duplex communication is performed by using only one earphone/microphone unit 5, the received voice sound output from the speaker 4 of the earphone/microphone unit 5 passes through the ear to become an echo, and then is picked up by the speaker 4 (second microphone), thereby generating an echo. In the DSP 39, in order to extract the transmitted voice sound (the voice sound which is generated in the ear when the headset user produces voice) buried in the received voice sound received from the speaker 4, therefore, a digital signal process of eliminating the echo is performed by using an adaptive filter (echo canceller). In the case where a bidirectional call of the full-duplex communication is performed by using only one earphone/microphone unit 5, the earphone/microphone LSI 40 enhances the clarity of the call.

As the Bluetooth LSI 38, for example, BlueCore3-Multimedia or BlueCore5-Multimedia (BlueCore: registered trademark) manufactured by CSR Limited may be used, and, as the earphone/microphone LSI 40, LC70701LG manufactured by SANYO Semiconductor Co., Ltd. may be used.

Although illustration is omitted in FIG. 4, the plural switches 42 other than the mode switchover switch 43 are connected to the Bluetooth LSI 38 similarly with the mode switchover switch 43. Although also illustration of the LEDs 26, 27 of the plurality of LEDs 7 other than the mode displaying LED 28 is omitted in FIG. 4, the LEDs 26, 27 are connected to the Bluetooth LSI 38 similarly with the mode displaying LED 28. Furthermore, illustration of the secondary battery 11 is omitted in FIG. 4.

The operations and functions of the thus configured headset 1 will be described.

When the headset 1 is to be used, the headset 1 is attached to one of the ears, and the power source of the headset 1 is turned on. The earphone/microphone unit 5 is inserted into the external auditory canal of the one ear, so that the headset 1 can be attached to the one ear in a state where the sound-pick up hole 15 of the headset housing 2 is directed to the mouth. In the headset 1, when the power source switch button 21 is pressed to turn on the power source switch, the power source supplied from the secondary battery 11 is converted to a voltage level corresponding to the portions of the Bluetooth module 10 and then supplied to the portions, and the turned-on state of the power source is set. In the case where the power source is turned on, when the speaker 4 of the earphone/microphone unit 5 is connected to the Bluetooth LSI 38 by the mode switchover switch circuit 41 in the state indicated by the clash-dot-dot line in FIG. 4, the headset 1 operates in the first call mode, and, when the speaker 4 of the earphone/microphone unit 5 is connected to the earphone/microphone LSI 40 by the mode switchover switch circuit 41 in the state indicated by the solid line in FIG. 4, the headset 1 operates in the second call mode.

In the first call mode, when the reception audio signal which is transmitted from the portable telephone by means of Bluetooth wireless communication is received through the antenna 37, the reception audio signal is supplied from an audio codec incorporated in the Bluetooth LSI 38, to the speaker 4 of the earphone/microphone unit 5 through the external mode switchover switch circuit 41, and then acoustically output (reproduced) from the speaker 4. The headset user can hear the voice sound of the other party via the one ear to which the headset 1 is attached. The audio input to the headset 1 is performed by the first microphone 3 which picks up a voice sound emitted from the mouth of the headset user. The transmission audio signal is supplied from the first microphone 3 to the audio codec of the Bluetooth LSI 38, and then transmitted from the antenna 37. The transmitted transmission audio signal is received by the portable telephone by means of Bluetooth wireless communication, and transmitted to the other party via a telephone network, so that the other party can hear the voice sound of the headset user. In the first call mode, as described above, a handsfree call is realized by using the first microphone 3 which picks up a voice sound emitted from the mouth of the headset user, and the speaker 4 (speaker function) of the earphone/microphone unit 5.

In the second call mode, by contrast, when the reception audio signal which is transmitted from the portable telephone by means of Bluetooth wireless communication is received through the antenna 37, the reception audio signal is supplied from the Bluetooth LSI 38 to the speaker 4 of the earphone/microphone unit 5 through the mode switchover switch circuit 41 via the external earphone/microphone LSI 40, and then acoustically output (reproduced) from the speaker 4. The headset user can hear the voice sound of the other party via the one ear to which the headset 1 is attached. The audio input to the headset 1 is performed by the speaker 4 (second microphone) of the earphone/microphone unit 5 which picks up a voice sound which is generated in the ear when the headset user produces voice. The transmission audio signal is supplied from the mode switchover switch circuit 41 to the Bluetooth LSI 38 via the earphone/microphone LSI 40, and then transmitted from the antenna 37. The transmitted transmission audio signal is received by the portable telephone by means of Bluetooth wireless communication, and transmitted to the other party via the telephone network, so that the other party can hear the voice sound of the headset user. In the second call mode, as described above, a handsfree call is realized by using only the speaker 4 (speaker function) of the earphone/microphone unit 5 that is identical with the speaker 4 (second microphone) of the earphone/microphone unit 5 which picks up a voice sound which is generated in the ear when the headset user produces voice, i.e., the one earphone/microphone unit 5.

The first and second call modes can be easily switched over simply by pressing the mode switchover switch button 25. In the case where the headset 1 is used in the first call mode, when the mode switchover switch button 25 is pressed, the mode switchover switch 43 which is in the on state is switched to the off state, and, based on the off input from the mode switchover switch 43, the Bluetooth LSI 38 performs a drive control to switch the state of the mode switchover switch circuit 41 from the state indicated by the dash-dot-dot line in FIG. 4 to that indicated by the solid line. This causes the speaker 4 of the earphone/microphone unit 5 which is connected to the Bluetooth LSI 38, to be switchingly connected to the earphone/microphone LSI 40, so that the call mode is switched from the first call mode to the second call mode. By contrast, in the case where the headset 1 is used in the second call mode, when the mode switchover switch button 25 is pressed, the mode switchover switch 43 which is in the off state is switched to the on state, and, based on the on input from the mode switchover switch 43, the Bluetooth LSI 38 performs a drive control to switch the state of the mode switchover switch circuit 41 from the state indicated by the solid line in FIG. 4 to that indicated by the dash-dot-dot line. This causes the speaker 4 of the earphone/microphone unit 5 which is connected to the earphone/microphone LSI 40, to be switchingly connected to the Bluetooth LSI 38, so that the call mode is switched from the second call mode the first call mode.

As described above, the headset 1 comprises: the first microphone 3 which picks up a voice sound emitted from the mouth; the earphone/microphone unit 5 in which the built-in speaker 4 functions also as the second microphone which picks up a voice sound generated in the ear; and the mode switchover switch circuit 41 (mode switching means) which switches over between the first call mode where the first microphone 3 and the speaker function of the earphone/microphone unit 5 are caused to operate, and the second call mode where the microphone and speaker functions of the earphone/microphone unit 5 are caused to operate. In the first call mode, the usual headset function is exerted, and, in the second call mode, the function of picking up a voice sound generated in the ear is exerted. The headset 1 has both the usual headset function and the function of picking up a voice sound generated in the ear, and the two functions can be easily switched over. The two functions can be selectively used depending on the service environment. In a quiet atmosphere, for example, a handsfree call is performed by using the usual headset function, and, in a noisy atmosphere, a handsfree call is performed by using the function of picking up a voice sound generated in the ear. Namely, the headset 1 has a service environment adaptability.

In the headset 1, the mode switchover switch button 25 and mode switchover switch 43 which are dedicated for switching between the first call mode (the usual headset mode) and the second call mode (the mode where a voice sound generated in the ear can be picked up) are disposed. However, they are not always required to be disposed. The mode switching may be performed in a software manner by using, for example, buttons and switches for basic operations of the headset 1, such as: the power source switch button 21 and the power source switch; the hook switch button 22 and the hook switch; and the volume up switch button 23, the volume down switch button 24, the volume up switch, and the volume down switch. For example, the mode switching may be performed in the following manner. A signal is supplied to the Bluetooth LSI 38 by two continuous pressings of the power source switch button 21 or a long pressing of the hook switch button 22. In response to the signal input, the mode switchover switch circuit 41 is driven controlled to perform the mode switching. When the buttons and switches for basic operations of the headset 1 are used also for the mode switching operation as described above, the mode switchover switch button 25 and mode switchover switch 43 which are dedicatedly used are not required, and hence the production cost and size of the headset 1 can be reduced.

When the power source is turned on, the headset 1 can operate in either of the first and second call modes. In initialization by the headset user, for example, it may be set so that the power source is turned on in any one of the first and second call modes. Alternatively, the power source may be turned on in a mode which is frequently used. When the power source of the headset 1 is turned off (when the power source switch button 21 is pressed to turn off the power source switch in the on state), the Bluetooth LSI 38 stores the mode which is set immediately before the power off, and the power source is turned on in the stored mode. In this case, the headset 1 can be made easy to use for the headset user.

In the headset 1, each time when various operations are performed (the switch buttons 6 are operated), the Bluetooth LSI 38 drives and controls the corresponding LEDs 26, 27, 28, so that the various states of the headset 1 are displayed to the headset user depending on differences of light emission colors or patterns. At the same time, simple audio signals corresponding to the various operations are output from the Bluetooth LSI 38, and notification sounds are output from the speaker, so that the various states of the headset 1 are notified to the headset user depending on differences of the kinds of the notification sounds.

When the various states of the headset 1 are notified by means of a sound, the kinds and qualities of the notification sounds may be made further different between the first and second call modes, so that, when the headset 1 is attached to one of the ears, the headset user can easily know which one of the modes is used. The notification sounds may be made different from one another with respect to all the operations, or limited ones of the operations. Particularly, the volume-up and -down operations are performed during a call. When the notification sounds for the operations are made different, therefore, it is effective in determination between the first and second call modes.

Also when the various states of the headset 1 are notified by LED displays, the light emission colors or patterns may be made further different between the first and second call modes, so that, when the headset 1 is detached from the one ear, the headset user can easily know which one of the modes is used. The light emission colors or patterns of the LEDs 26, 27, 28 may be made different from one another with respect to all the operations, or limited ones of the operations.

In the headset 1, the first microphone 3 which picks up a voice sound emitted from the mouth of the headset user is used for inputting a voice sound in the first call mode, and hence a transmission audio signal which is similar to a natural voice sound can be obtained, but, in the second call mode, the first microphone 3 is not used, and the speaker 4 (second microphone) of the earphone/microphone unit 5 which picks up a voice sound which is generated in the ear when the headset user produces voice is used, and hence the voice sound tends to be muffled, so that a transmission audio signal which is similar to a natural voice sound cannot be obtained (a voice sound which is generated in the ear is attenuated in the high-frequency region as compared with a voice sound emitted from the mouth, and tends to be lowered in quality). In the second call mode, therefore, the DSP 39 which is incorporated in the earphone/microphone LSI 40 is used, and an equalizing adjustment process is performed to correct the high-frequency region, thereby improving the characteristics of the intra-ear sound which tends to be muffled. In the DSP 39, also a digital signal process of removing noises by using a noise canceller is performed simultaneously with the removal of echo.

In addition to the equalizing adjustment which is performed on the side of the earphone/microphone LSI 40 as the high-frequency correction as described above, the following process may be performed. In the second call mode, also the first microphone 3 is daringly operated, and a Bluetooth LSI which incorporates a DSP that can perform an equalizing adjustment process as the high-frequency correaction is used, thereby enabling an equalizing adjustment process to be performed as the high-frequency correction on the side of the Bluetooth LSI on the basis of the audio signal supplied from the first microphone 3. In this case, the first microphone 3 can be used for the high-frequency correction, and also for the hearing aid that enables an external sound to be heard by the ear to which the headset 1 is attached. For example, an operation button and switch which are dedicated for hearing aid may be added, or a button and switch for basic operations of the headset 1 may be used also for hearing aid, and, only when the button is pressed (the switch is turned on), an external sound may be enabled to be heard by the ear to which the headset 1 is attached. For example, BlueCore3-Multimedia or BlueCore5-Multimedia (BlueCore: registered trademark) manufactured by CSR Limited is a Bluetooth LSI which incorporates a DSP.

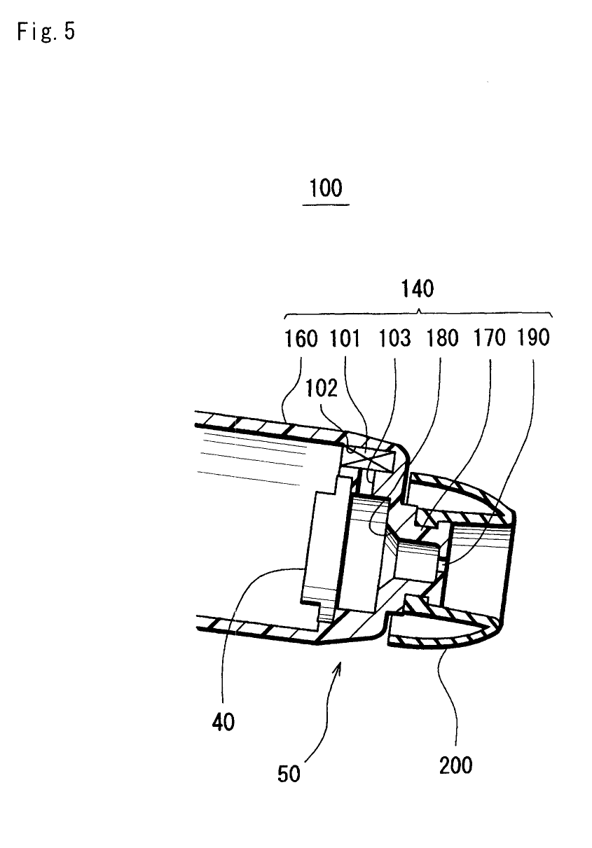

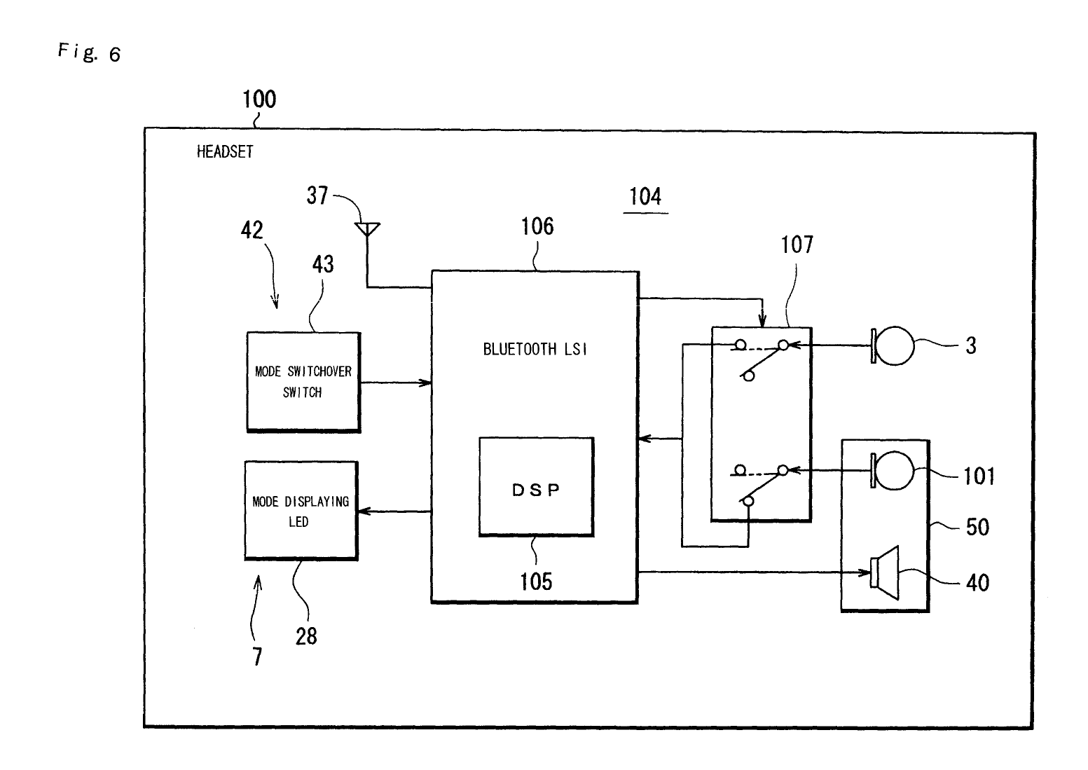

Next, an embodiment of Invention 2 will be described with reference to FIGS. 5 and 6.

The headset of Invention 1 comprises the earphone/microphone unit in which the built-in speaker functions also as the second microphone which picks up a voice sound generated in the ear, and the LSI dedicated for the earphone/microphone unit. By contrast, the headset of Invention 2 is different in that it comprises an earphone/microphone unit which separately incorporates a speaker and a second microphone which picks up a voice sound generated in the ear, and does not comprise an LSI dedicated for the earphone/microphone unit.

FIG. 5 is a sectional view of main portions (an earphone/microphone unit) of a headset which is an embodiment of Invention 2. In the figure, portions which are structured in the same manner as those of the headset of the embodiment of Invention 1 are denoted by identical reference numerals, and their detailed description is omitted.

As shown in FIG. 5, the headset 100 comprises an earphone/microphone unit 50 in place of the earphone/microphone unit 5. The earphone/microphone unit 50 is formed into a canal type earphone shape by: an earphone/microphone housing portion 140 which is formed into a stepped tubular shape, which has a large-diameter portion 160 in the base side of the tubular shape, and a small-diameter portion 170 in the tip-end side of the tubular shape, and in which a sound guiding hole 180 is formed inside the tubular shape, and a sound hole 190 through which the sound guiding hole 180 communicates to the outside is opened in the tip end of the tubular shape; a speaker 40 which is disposed in the rear side (in the middle of the sound guiding hole 180) of the large-diameter portion 160; and a canal-shaped earpiece 200 made of an elastic material such as silicone rubber which is fitted onto the small-diameter portion 170. The earphone/microphone unit is used while being inserted into the external auditory canal of one of the ears.

In addition to the speaker 40, a second microphone 101 is disposed in the earphone/microphone unit 50. In the earphone/microphone housing portion 140, a microphone hosing portion 102 is disposed in a peripheral wall of the large-diameter portion 160, and a branching sound guiding hole 103 which branches from the sound guiding hole 180 between the speaker 40 and the sound hole 190, and which communicates with the microphone hosing portion 102 are disposed. The second microphone 101 is disposed in the microphone hosing portion 102, and picks up a voice sound generated in the ear when the headset user produces voice, through the sound hole 190, the sound guiding hole 180, and the branching sound guiding hole 103.

FIG. 6 is a schematic block diagram of a Bluetooth module of the headset of FIG. 5. In the figure, portions which are structured in the same manner as those of the Bluetooth module of the embodiment of Invention 1 are denoted by identical reference numerals, and their detailed description is omitted.

As shown in FIG. 6, the Bluetooth module 104 comprises: a Bluetooth LSI 106 which is used in place of the Bluetooth LSI 38, and which incorporates a DSP 105; a mode switchover switch circuit 107 which is used in place of the mode switchover switch circuit 41; and the like.

The speaker 40 of the earphone/microphone unit 50 is always connected to the Bluetooth LSI 106, and the first microphone 3 and the second microphone 101 of the earphone/microphone unit 50 are switchably connected to the Bluetooth LSI 106 by the mode switchover switch circuit 107.

The Bluetooth LSI 106 performs transmission/reception of a voice sound and its control with respect to a portable telephone having a Bluetooth wireless communication function, by means of Bluetooth wireless communication, and also various controls in the headset 100. The DSP 105 incorporated in the Bluetooth LSI 106 exerts the same function as that of the DSP 39 incorporated in the earphone/microphone LSI 40. Also in the earphone/microphone unit 50, in the case where a bidirectional call of the full-duplex communication is performed by using only one earphone/microphone unit 50, the received voice sound output from the speaker 40 passes through the ear to become an echo, and then is picked up by the second microphone 101, thereby generating an echo. In the DSP 105, in order to extract the transmitted voice sound (the voice sound which is generated in the ear when the headset user produces voice) buried in the received voice sound received from the speaker 40, therefore, a digital signal process of eliminating the echo is performed by using an adaptive filter (echo canceller). In the case where a bidirectional call of the full-duplex communication is performed by using only one earphone/microphone unit 50, the DSP 105 enhances the clarity of the call. Furthermore, the DSP performs also an equalizing adjustment process as the high-frequency correction, and a digital signal process of removing noises by using a noise canceller.

The operations and functions of the thus configured headset 100 will be described.

When the headset 100 is to be used, the headset 100 is attached to one of the ears, and the power source of the headset 100 is turned on. In the case where the power source is turned on, when the first microphone 3 is connected to the Bluetooth LSI 106 by the mode switchover switch circuit 107 in the state indicated by the dash-dot-dot line in FIG. 6, the headset 100 operates in the first call mode, and, when the second microphone 101 of the earphone/microphone unit 50 is connected to the Bluetooth LSI 106 by the mode switchover switch circuit 107 in the state indicated by the solid line in FIG. 6, the headset operates in the second call mode.

In the first call mode, when the reception audio signal which is transmitted from the portable telephone by means of Bluetooth wireless communication is received through the antenna 37, the reception audio signal is supplied from the DSP 105 incorporated in the Bluetooth LSI 106 to the speaker 40 of the earphone/microphone unit 50 through an audio codec, and then acoustically output (reproduced) from the speaker 40. The headset user can hear the voice sound of the other party via the one ear to which the headset 100 is attached. The audio input to the headset 100 is performed by the first microphone 3 which picks up a voice sound emitted from the mouth of the headset user. The transmission audio signal is supplied from the first microphone 3 to the audio codec of the Bluetooth LSI 106, and then transmitted from the antenna 37 through the DSP 105. The transmitted transmission audio signal is received by the portable telephone by means of Bluetooth wireless communication, and transmitted to the other party via a telephone network, so that the other party can hear the voice sound of the headset user. In the first call mode, as described above, a handsfree call is realized by using the first microphone 3 which picks up a voice sound emitted from the mouth of the headset user, and the speaker 40 of the earphone/microphone unit 50.

In the second call mode, by contrast, when the reception audio signal which is transmitted from the portable telephone by means of Bluetooth wireless communication is received through the antenna 37, the reception audio signal is supplied from the DSP 105 incorporated in the Bluetooth LSI 106, to the speaker 40 of the external earphone/microphone unit 50 through the audio codec, and then acoustically output (reproduced) from the speaker 40, similarly with the first call mode. The headset user can hear the voice sound of the other party via the one ear to which the headset 100 is attached. The audio input to the headset 100 is performed by the second microphone 101 of the earphone/microphone unit 50 which picks up a voice sound which is generated in the ear when the headset user produces voice. The transmission audio signal is supplied from the second microphone 101 to the audio codec of the Bluetooth LSI 106, and then transmitted from the antenna 37 through the DSP 105. The transmitted transmission audio signal is received by the portable telephone by means of Bluetooth wireless communication, and transmitted to the other party via a telephone network, so that the other party can hear the voice sound of the headset user. In the second call mode, as described above, a handsfree call is realized by using only the second microphone 101 of the earphone/microphone unit 50 which picks up a voice sound which is generated in the ear when the headset user produces voice, and the speaker 40 of the earphone/microphone unit 50, i.e., the one earphone/microphone unit 50.

The first and second call modes can be easily switched over simply by pressing the mode switchover switch button 25. In the case where the headset 100 is used in the first call mode, when the mode switchover switch button 25 is pressed, the mode switchover switch 43 which is in the on state is switched to the off state, and, based on the off input from the mode switchover switch 43, the Bluetooth LSI 106 performs a drive control to switch the state of the mode switchover switch circuit 107 from the state indicated by the dash-dot-dot line in FIG. 6 to that indicated by the solid line. This causes the second microphone 101 of the earphone/microphone unit 50 to be connected to the Bluetooth LSI 106, in place of the first microphone 3, so that the call mode is switched from the first call mode to the second call mode. By contrast, in the case where the headset 100 is used in the second call mode, when the mode switchover switch button 25 is pressed, the mode switchover switch 43 which is in the off state is switched to the on state, and, based on the on input from the mode switchover switch 43, the Bluetooth LSI 106 performs a drive control to switch the state of the mode switchover switch circuit 107 from the state indicated by the solid line in FIG. 6 to that indicated by the dash-dot-dot line. This causes the first microphone 3 to be connected to the Bluetooth LSI 106 in place of the speaker 40 of the earphone/microphone unit 50, so that the call mode is switched from the second call mode to the first call mode.

As described above, the headset 100 comprises: the first microphone 3 which picks up a voice sound emitted from the mouth; the earphone/microphone unit 50 which separately incorporates the speaker 40 and the second microphone 101 which picks up a voice sound generated in the ear; and the mode switchover switch circuit 107 (mode switching means) which switches over between the first call mode where the first microphone 3 and the speaker 40 of the earphone/microphone unit 50 are caused to operate, and the second call mode where the speaker 40 of the earphone/microphone unit 50 and the second microphone 101 are caused to operate. In the first call mode, the usual headset function is exerted, and, in the second call mode, the function of picking up a voice sound generated in the ear is exerted. The headset 100 has both the usual headset function and the function of picking up a voice sound generated in the ear, and the two functions can be easily switched over. The two functions can be selectively used depending on the service environment. In a quiet atmosphere, for example, a handsfree call is performed by using the usual headset function, and, in a noisy atmosphere, a handsfree call is performed by using the function of picking up a voice sound generated in the ear. Namely, the headset 100 has a service environment adaptability.

The other operations and functions of the headset 100 are identical with those of the headset 1.

Although preferred embodiments of Inventions 1 and 2 have been described, Inventions 1 and 2 are not restricted to them, and may be variously modified without departing from the spirits of the inventions. For example, the Bluetooth LSI is an example of short-range wireless communicating means which wirelessly connects the headset to a portable telephone, and which performs voice communication therebetween. Alternatively, other short-range wireless communicating means may be used. Most of functions which are necessary in short-range wireless communication may not be integrated into one chip, but realized by combining discrete circuits with one another. Furthermore, the earphone/microphone LSI is an example of a digital signal process (DSP) which, when a bidirectional call of the full-duplex communication is performed by using only one earphone/microphone unit, enhances the clarity of the call. Most of functions which are necessary in the digital signal process may not be integrated into one chip, but realized by combining discrete circuits with one another. The dynamic type speaker is an example of a speaker which can function also as a microphone. The speaker may be a speaker other than the dynamic type.

### DESCRIPTION OF REFERENCE NUMERALS

1, 100 headset
3 first microphone
4, 40 speaker
5, 50 earphone/microphone unit
41, 107 mode switchover switch circuit (mode switching means)
   101 second microphone

What is claimed is:

1. A headset wherein
said headset comprises:
a first microphone which picks up a voice sound emitted from a mouth;
an earphone/microphone unit in which a built-in speaker functions also as a second microphone which picks up a voice sound generated in an ear; and
a mode switchover switch circuit which switches over between a first call mode and a second call mode,
the first call mode is a call mode in which said first microphone and a speaker function of said earphone/microphone unit are caused to operate, and
the second call mode is a call mode in which a microphone function and speaker function of said earphone/microphone unit are caused to operate.

2. A headset wherein
said headset comprises:
a first microphone which picks up a voice sound emitted from a mouth;
an earphone/microphone unit which separately incorporates a speaker and a second microphone which picks up a voice sound generated in an ear; and
a mode switchover switch circuit which switches over between a first call mode and a second call mode,
the first call mode is a call mode in which said first microphone and said speaker of said earphone/microphone unit are caused to operate, and
the second call mode is a call mode in which said speaker and second microphone of said earphone/microphone unit are caused to operate.
